(19) United States
(12) Patent Application Publication
(10) Pub. No.: US 2017/0171330 A1
(43) Pub. Date: Jun. 15, 2017

(54) METHOD FOR PUSHING INFORMATION AND ELECTRONIC DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Zhendong KE, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/241,868

(22) Filed: Aug. 19, 2016

Related U.S. Application Data
(63) Continuation of application No. PCT/CN2016/089532, filed on Jul. 10, 2016.

(30) Foreign Application Priority Data
Dec. 15, 2015 (CN) 2015109336421

(51) Int. Cl. H04L 29/08; H04L 12/58; G06F 17/30

(52) U.S. Cl. CPC H04L 67/26; H04L 67/22; G06F 17/30979; H04L 51/12

(57) ABSTRACT

A method for pushing information and an electronic device are provided. The method includes: determining an information type of a user's interest and the degree of interest in the information type; and weighting, according to a characteristic quantity of information in a source information base and the degree of interest in the information of the user, the information in the source information base; and in a case in which the weighted value of the information exceeds a preset value, pushing the information to a client.

### CROSS-REFERENCE TO RELATED APPLICATIONS

The present application is a continuation of PCT application No. PCT/CN2016/089532 submitted on Jul. 10, 2016, which is based upon and claims priority to Chinese Patent Application No. 201510933642.1, filed with the Chinese Patent Office on Dec. 15, 2015 and entitled “INFORMATION PUSHING METHOD AND INFORMATION PUSHING APPARATUS”, both of which are incorporated herein by reference in their entireties.

### TECHNICAL FIELD

The present disclosure relates to the field of information pushing, and specifically, to a method and electronic device for pushing information.

### BACKGROUND

With the rapid development of network technologies, information required by users can be presented by means of various APPs, for example, text information, picture information, sound information, and video information, etc. To be able to provide more information in which users may interested to further improve a degree of satisfaction of the users, at present, a great number of APPs usually recommend to the users information of their possible interest, so that information that the users need can be directly presented to the users, thereby reducing requirements of the users for searching.

However, at present, screening to-be-pushed information is based only on an information browser history of a user, and information to-be-pushed is determined by means of an existing information base, and then recommended to the user. The information pushed by the foregoing pushing means cannot accurately match information of the user's real interest, that is, the information usually contains much information uninteresting for the user.

### SUMMARY

The present disclosure provides a method for pushing information and electronic device which enable information of a user's interest to be more accurately pushed to the user, thereby greatly improving a degree of satisfaction of the user.

According to a first aspect, an embodiment of the present disclosure provides an information pushing method. The information pushing method includes: determining an information type of a user's interest and the degree of interest in the information type; weighting the information in a source information base, according to a characteristic quantity of information in the source information base and the degree of interest of the user in the information; and in a case in which a weighted value of the information exceeds a preset value, pushing the information to a client.

According to a second aspect, an embodiment of the present disclosure further provides a non-transitory computer-readable storage medium, which stores computer executable instructions that, when executed by an electronic device, cause the electronic device to perform any of the above methods of the present disclosure.

According to a third aspect, an embodiment of the disclosure further provides an electronic device, including: at least one processor; and a memory, where the memory stores instructions that can be executed by the at least one processor, and the instructions is executed by the at least one processor, cause the at least one processor to perform any of the above methods of the present disclosure.

### A BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

Accompanying drawings are used to provide a further understanding of the present disclosure and constitute a part of the specification. Together with the following specific implementation manners, the drawings are used to explain the present disclosure, and do not constitute a limitation to the present disclosure. In the accompanying drawings:

FIG. 1 is a flowchart of a method for pushing information according to Embodiment 1 of the present disclosure; and

FIG. 2 is a schematic structural diagram of an apparatus for pushing information according to Embodiment 1 of the present disclosure; and

FIG. 3 is a schematic structural diagram of an electronic device according to Embodiment 3 of the disclosure.

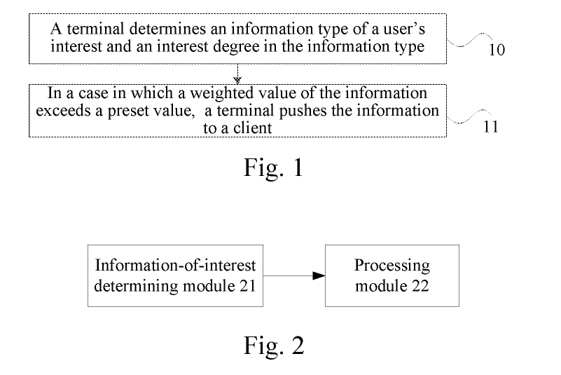

### LIST OF REFERENCE NUMERALS

21 Information-of-interest determining module 22 processing module

### DETAILED DESCRIPTION

To make the objectives, technical solutions, and advantages of the present disclosure clearer, hereinafter, the technical solutions of the present disclosure will be clearly and completely described by implementation manners with reference to the accompanying drawings in the embodiments of the present disclosure. Apparently, the described embodiments are a part rather than all of the embodiments of the present disclosure.

### Embodiment 1

FIG. 1 is a flowchart of an information pushing method according to an embodiment of the present disclosure. As shown in FIG. 1, the information pushing method provided by this embodiment may include: in step 10, an information type of a user's interest and the degree of interest in the information type is determined; and in step 11, information in a source information base is weighted, according to a characteristic quantity of the information in the source information base and the degree of interest of the user in the information, and in a case in which the weighted value of the information exceeds a preset value, the information is pushed to a client. In this way, information matching with information of the user's interest can be more accurately pushed to the user, thereby improving user experience.

An information type of a user's interest and the degree of interest of the user in the information type may be determined according to information that the user views and/or searches for. For example, the degree of interest of the user in the information type is determined according to the number of times of viewing and/or searching for information of the information type. The information may be text information, picture information, sound information, video information and/or the like, to which this embodiment is certainly not limited.

The characteristic quantity of the information in the source information base needs to meet a preset condition. The characteristic quantity of the information may be at least one of the following: a number of clicks, a click-through rate, and timeliness. When information meets at least one of the following preset conditions, the information may be added to the source information base: a number of clicks of the information exceeds a preset value; a click-through rate of the information exceeds a preset value; and the information meet timeliness (for example, the information was published within a week, etc.).

To further ensure that information finally pushed more accurately matches with information of a user's interest, the information pushing method further includes establishing a junk information list, where the junk information list includes an information type of which information is determined to be junk information. The information may be classified into multiple types according to different aspects, for example, classified into types of politics, entertainment, and life, etc., according to a first classification manner; or classified into types according to authors or performers; or classified into types of songs, instrumental performance, and public square dancing, etc., according a form of expression. However, in this embodiment, an information type of the junk information is mainly determined according to an attention degree of all users that use an APP to an information type of information. If less than a preset number of users pay attention to an information type of information, this information type is added to the junk information list. In addition, an information type of the junk information may also be added in the information list by manual input.

In a case in which junk information matching with information in the junk information list in the source information base and the junk information does not belong to the information type of a user's interest, the junk information may be blocked for the user. The so-called blocking refers to that the junk information is not pushed to the user to further screen source information so as to ensure high matching between information pushed to the user and the information of the user's interest. After finishing screening junk information, information that does not belong to the junk information is weighted according to a characteristic quantity of the information and the degree of interest in the information, and in a case in which the weighted value of the information exceeds the preset value, the information is pushed to a client.

This embodiment is described in detail by means of a specific implementation manner in the following, however, it should be noted that this embodiment is not limited thereto.

A user A often views or searches for a song of Legend Of Phoenix in a video APP, but basically, the user does not view or search for a video related to public square dancing. Therefore, for this user, a larger weight is allocated to information with a characteristic quantity of the song Legend Of Phoenix, and a weight less than a preset value is allocated to the related video with a characteristic quantity of the public square dancing, i.e., information of a public-square-dancing type is determined to be an information type uninteresting for the user A, and the public-square-dancing type is stored in a information list. According to the information pushing method provided by this embodiment, because the public-square-dancing type in the junk information list, and the user A is not interested in the public-square-dancing type of information, when the public square dancing with respect to the song of Legend Of Phoenix occurs, because the information belongs to the public-square-dancing type, even if the public square dancing uses the song of Legend Of Phoenix as an accompaniment song, a server will still block the information and will not push it to the user A. On the contrary, if it is determined that the user A is also interested in the public-square-dancing type of video information, and the number of clicks in the information is very large, therefore, a weight allocated to the characteristic quantity of the information is also larger, then according to the information pushing method provided by this embodiment, the server will weight the information according to the characteristic quantity of the information and the degree of interest in the information for the user A. Because a weighted value of the two is larger, and the weighted value will exceed the preset value, the server will push the information of the song of Legend Of Phoenix belonging to the public-square-dancing type to a client, so as to recommend to the user. In this way, the information of the user's interest can be accurately recommended to the user, thereby improving user experience.

Correspondingly, embodiments of the present disclosure further provide an apparatus for pushing information. FIG. 1 is a schematic structural diagram of an apparatus for pushing information according to this embodiment. As described in FIG. 1, the apparatus for pushing information provided by this embodiment may include: an information-of-interest determining module 21, and a processing module 22. The information-of-interest determining module 21 determines an information type of a user's interest and the degree of interest in the information type; and the processing module 22 weights information in a source information base, according to a characteristic quantity of the information in the source information base and the degree of interest of the user in the information, and in a case in which the weighted value of the information exceeds a preset value, pushes the information to a client. In this way, information matching with the information of the user's interest can be more accurately pushed to the user, thereby improving user experience.

The information-of-interest determining module 21 may determine the information type of the user's interest and the degree of interest of the user in the information type according to information that the user views and/or searches for. For example, the degree of interest of the user in the information type is determined according to the number of times of viewing and/or searching for the information type of information. The information may be text information, picture information, sound information, video information and/or the like, to which this embodiment is certainly not limited.

The characteristic quantity of the information in the source information base needs to meet a preset condition. Therefore, the information pushing apparatus may further include a source information determining module configured to add information of which the characteristic quantity meets the preset condition to the source information base. The characteristic quantity of the information may be at least one of the following: a number of clicks, a click-through rate, and timeliness. When information meets at least one of the following preset conditions, the information may be added to the source information base: a number of clicks of the information exceeds a preset value; a click-through rate of the information exceeds a preset value; and the information meets timeliness (for example, the information was published within a week, etc.).

To further ensure that information finally pushed more accurately matches with the information of the user's interest, the information pushing apparatus may further include a list-establishing module configured to establish a junk information list, where the junk information list includes an information type of which information is determined to be junk information. The information may be classified into multiple types according to different aspects, for example, classified into types of politics, entertainment, and life, etc., according to a first classification manner; or classified into types according to authors or performers; or classified into types of songs, instrumental performance, and public square dancing, etc., according to a form of expression. However, in this embodiment, an information type of the junk information is mainly determined according to an attention degree of all users that use an APP to an information type of information. If less than a preset number of users pay attention to the information type of the information, this information type is added to the junk information list. In addition, an information type of the junk information may also be added in the information list by manual input.

The processing module 22 may further block the junk information for the user in a case in which junk information matching with information in the junk information list in the source information base and the junk information does not belong to the information type of the user's interest. The so-called blocking refers to that the junk information is not pushed to the user to further screen source information, so as to ensure high matching between information pushed to the user and the information of the user's interest.

After finishing screening junk information, information that does not belong to the junk information is weighted according to a characteristic quantity of the information and the degree of interest in the information, and in a case in which the weighted value of the information exceeds the preset value, the information is pushed to a client.

### Embodiment 2

Embodiment 2 of this disclosure provides a non-transitory computer-readable storage medium, which stores computer executable instructions that, when executed by an electronic apparatus, cause the electronic apparatus to perform the information pushing method of any of the foregoing method embodiments of the disclosure.

### Embodiment 3

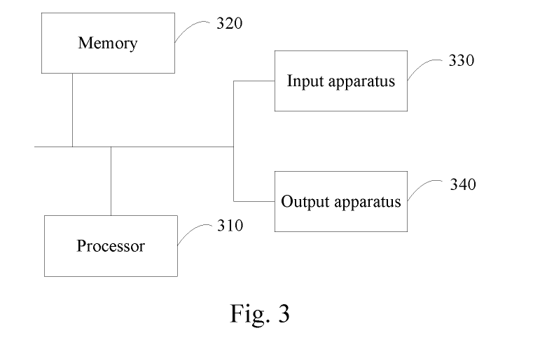

FIG. 3 is a schematic structural diagram of hardware of an electronic device for executing an information pushing method provided by Embodiment 3 of the disclosure. As shown in FIG. 5, the device includes:

one or more processors 310 and a memory 320, with one processor 310 as an example in FIG. 3.

A device for the information pushing method may further include: an input apparatus 330 and an output apparatus 340.

The processor 310, the memory 320, the input apparatus 330, and the output apparatus 340 can be connected by means of a bus or in other manners, with a connection by means of a bus as an example in FIG. 3.

As a non-transitory computer-readable storage medium, the memory 320 can be used to store non-transitory software programs, non-transitory computer-readable executable programs and modules, for example, program instructions/module corresponding to the information pushing method in the embodiments of the disclosure. The processor 310 executes various functional applications and data processing of the server, that is, implements the information pushing method of the foregoing method embodiments, by running the non-transitory software programs, instructions, and modules stored in the memory 320.

The memory 320 may include a program storage area and a data storage area, where the program storage area may store an operating system and at least one disclosure needed by function; the data storage area may store weighting the information in the source information base, according to a characteristic quantity of information in a source information base and the degree of interest of the user in the information, and in a case in which the weighted value of the information exceeds a preset value, pushing the information to a client, and the like. In addition, the memory 320 may include a high-speed random access memory, and also may include a non-transitory memory, such as at least one disk storage device, flash storage device, or other non-transitory solid-state storage devices. In some embodiments, the memory 320 optionally includes memories remotely disposed with respect to the processor 310, and the remote memories may be connected, via a network, to the information pushing device. Examples of the foregoing network include but are not limited to: the Internet, an intranet, a local area network, a mobile communications network, and a combination thereof.

The input apparatus 330 can receive entered digit or character information, and generate key signal inputs relevant to user setting and functional control of the information pushing device. The output apparatus 340 may include a display device, for example, a display screen, etc.

The one or more modules are stored in the memory 320, and execute the information pushing method in any one of the foregoing method embodiments when being executed by the one or more processors 310.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

1. A method for pushing information applied to a terminal, comprising:
determining an information type of a user's interest and a degree of interest in the information type; and
weighting according to a characteristic quantity of information in a source information base and the degree of interest in the information of the user, the information in the source information base; and,
in a case in which the weighted value of the information exceeds a preset value, pushing the information to a client.

2. The method according to claim 1, further comprising:
establishing a junk information list; and
in a case in which there is junk information matching with information in the junk information list in the source information base, and the junk information does not belong to the information type of the user's interest, blocking the junk information for the user.

3. The method according to claim 1, wherein the information type of the user's interest and the degree of interest in the information type are determined according to information that the user views and/or searches for.

4. The method according to claim 1, wherein the characteristic quantity of the information is at least one of the following: a number of clicks, a click-through rate, and timeliness.

5. A non-transitory computer-readable storage medium which stores computer executable instructions that, when executed by an electronic device, cause the electronic device to:
determine an information type of a user's interest and a degree of interest in the information type; and
weight, according to a characteristic quantity of information in a source information base and the degree of interest of the user in the information, the information in the source information base, and
in a case in which the weighted value of the information exceeds a preset value, push the information to a client.

6. The non-transitory computer-readable storage medium according to claim 5, wherein the electronic device is further caused to:
establish a junk information list; and
in a case in which there is junk information matching with information in the junk information list in the source information base, and the junk information does not belong to the information type of the user's interest, block the junk information for the user.

7. The non-transitory computer-readable storage medium according to claim 6, wherein the information type of the user's interest and the degree of interest of the user in the information type are determined according to information that the user views and/or searches for.

8. The non-transitory computer-readable storage medium according to claim 5, wherein the characteristic quantity of the information is at least one of the following: a number of clicks, a click-through rate, and timeliness.

9. The non-transitory computer-readable storage medium according to claim 7, wherein the characteristic quantity of the information is at least one of the following: a number of clicks, a click-through rate, and timeliness.

10. The non-transitory computer-readable storage medium according to claim 5, wherein the information type of the user's interest and the degree of interest in the information type are determined according to information that the user views and/or searches for.

11. The method according to claim 2, wherein the information type of the user's interest and the degree of interest in the information type are determined according to information that the user views and/or searches for.

12. The method according to claim 2, wherein the characteristic quantity of the information is at least one of the following: a number of clicks, a click-through rate, and timeliness.

13. An electronic device, comprising:
at least one processor; and
a memory in communication connection with the at least one processor,
wherein the memory stores instructions that can be executed by the at least one processor, and execution of the instructions by the at least one processor, causes the at least one processor to:
determine an information type of a user's interest and the degree of interest in the information type; and
weight, according to a characteristic quantity of information in a source information base and the degree of interest of the user in the information, the information in the source information base, and
in a case in which the weighted value of the information exceeds a preset value, push the information to a client.

14. The electronic device according to claim 13, wherein the at least one processor is further caused to:
establish a junk information list; and
in a case in which there is junk information matching with information in the junk information list in the source information base, and the junk information does not belong to the information type of the user's interest, block the junk information for the user.

15. The electronic device according to claim 13, where the information type of the user's interest and the degree of interest of the user in the information type are determined according to information that the user views and/or searches for.

16. The electronic device according to claim 14, where the information type of the user's interest and the degree of interest of the user in the information type are determined according to information that the user views and/or searches for.

17. The electronic device according to claim 13, wherein the characteristic quantity of the information is at least one of the following: a number of clicks, a click-through rate, and timeliness.

18. The electronic device according to claim 14, wherein the characteristic quantity of the information is at least one of the following: a number of clicks, a click-through rate, and timeliness.
